(19) United States
(12) Patent Application Publication
(10) Pub. No.: US 2012/0250466 A1
(43) Pub. Date: Oct. 4, 2012

(54) Universal Mounting Appliance for a Marine Transducer

(76) Inventor: Chris Allen, Rowlett, TX (US)

(21) Appl. No.: 13/075,011

(22) Filed: Mar. 29, 2011

(51) Int. Cl. G10K 11/00

(52) U.S. Cl. 367/173

(57) ABSTRACT

The invention provides advances in the arts with useful and novel mounting devices for mounting a transducer or other device to a watercraft hull. Preferred embodiments include a forward plate to mount to the transom of the boat hull, a first housing to detachably connect to the forward plate, and a second housing to detachably connect to the first housing in an arrangement suitable for mounting a transducer or other device.

### TECHNICAL FIELD

The present invention relates to a mounting device and more particularly to a mounting device for attaching marine transducer apparatus to a watercraft hull.

### BACKGROUND OF THE INVENTION

Navigation is the act of traversing waters safely and efficiently. Mariners, as ancient as 3500 B.C., had a need to devise methods to determine vessel speed, location, distance travelled, water depth and the ability to mark or locate underwater hazards as accurately as possible. Today, mariners, recreational and commercial fishermen and women and other users of watercraft of all types have the same basic navigation needs as those of long ago to mark and record vessel speed, location, depth, structure and hazards or to seek out and locate schools of fish. The attachment of myriad types of apparatus such as navigation transducer devices to the exterior transom portion of a vessel hull has become an accepted practice.

The ongoing desire among watercraft users to navigate more safely and efficiently, coupled with the increased interest in new technology of advanced marine electronic transducer capability has proved encouragement enough for boaters to install or refit their vessels. Boat owners may choose to install multiple types of electronics, each requiring transducers, on the exterior of the transom of his or her vessel, each performing a particular function.

Transducers, mounting brackets and accessories must be durable and constructed of quality materials to withstand the forces of water, corrosion, fouling marine life, and electrolysis.

Mariners have sought to improve methods of transducer attachment to the exterior transom portion of a vessel hull to enhance convenience and accuracy. Users of watercraft will find an array of clamps, hooks, adjustable rods, gunwale brackets, mounting boards and suction devices, to which transducers may be attached, and may also find such apparatus cumbersome, inconvenient, lacking precision and damaging. One problem may be that transducer mounting brackets are, at best, basic in design and lack functions to provide for improved installation, transducer management, adjustment capabilities for precise transducer optimization and may place the transducer much too closely to the transom of fast moving boats.

Another problem may be that many hull designs, which include deep deadrise V-hull boats, are not suited for mounting many types of transom-mounted transducers. Manufacturers of transducers often provide disclaimers with transducer electronics suggesting to avoid mounting transom transducers on a hull having a deadrise greater than a particular degree angle.

U.S. Pat. No. 5,529,272 discloses a portable adjustable transducer holder which attaches using screw-type clamps to the top edge of a boat transom.

U.S. Pat. No. 6,490,229 discloses a transducer mounting band designed for use to secure a transducer to the housing of a trolling motor. When fastened securely, the apparatus becomes rigid, securing the transducer tightly to the bottom side of the trolling motor housing. The secure attachment prevents the transducer from being knocked loose and lost or knocked out of alignment due to impact from underwater obstructions while the trolling motor is propelling the boat.

U.S. Pat. No. 6,928,948 discloses a mounting system for attaching a transducer to a surface such as the transom of a boat hull. The system consists of a mounting block, fasteners, and an item that the installer wishes to attach (such as a transducer or a plate). The block is formed of corrosion-resistant material. The block has an adhesive layer that bonds the block to the hull surface; no fasteners are required to mount the block to the surface. The block has at least one T-shaped slot that retains corrosion-resistant fasteners when tightened.

U.S. Pat. No. 7,036,451 discloses an apparatus for mounting underwater marine detection equipment designed to be mounted on the side of a waterborne vessel. The apparatus consists of a rotatable shaft long enough to extend below the bottom surface of the waterborne vessel. The marine detection equipment mount has means to secure marine detection equipment.

U.S. Pat. No. 7,548,490 discloses a transducer releasable mounting apparatus attached to the transom or hull of a watercraft. A marine acoustic transducer or sonar pod is affixed to the adapter so that the transducer or sonar pod is maintained at a selected depth and orientation below the surface of the water. A suction cup and a plate are attached on opposite sides of the first support member at the second end thereof.

U.S. Pat. No. 5,186,428 discloses a retractor device for selectively positioning a depth gauge transducer into the water or retracting it to an upwardly facing position above the water line. A compound lever system allows for rotation of the transducer assembly.

U.S. Pat. No. 5,016,225 discloses a portable and adjustable means for holding a measuring device and its display unit, and more particularly an apparatus for supporting a boat sonar transducer and its depth-finding display unit. The invention provides a sturdy means for both holding a sonar transducer or other measuring device below the water level and supporting the depth-finder or other display unit within the boat in a readily accessible position. A tube hooks onto the upper ledge of the transom of the boat by means of a tube block consisting of a tightening screw on one side and a boat clamp with a tightening screw on the other.

Due to the foregoing and possibly other problems, improved universal mount apparatus for mounting transducers and other devices on watercraft hulls would be useful and advantageous contributions to the applicable arts.

### SUMMARY OF THE INVENTION

In carrying out the principles of the present invention, in accordance with preferred embodiments, the invention provides advances in the arts with useful and novel hull mounting apparatus and systems. Variations in the practice of the invention are possible and exemplary preferred embodiments are illustrated and described. All possible variations within the scope of the invention cannot, and need not, be shown. It should be understood that the invention may be used with various transducer types and configurations, and alternative electronic apparatus and components.

In an example of a preferred embodiment of the invention, a mounting device for mounting a transducer to the transom of a boat hull may include a forward plate to mount to the transom of the boat hull, a first housing to detachably connect to the forward plate, and a second housing to detachably connect to the first housing.

In another example of a preferred embodiment of the invention, the first housing may include a first slot to cooperate with a fastening device to connect the transducer to the second housing, and the second housing may include a second slot to cooperate with the fastening device and to cooperate with the first slot to connect the transducer to the second housing.

In another example of a preferred embodiment of the invention, the first housing may include an open forward side, and the second housing may include an open forward side.

In further examples of one aspect of the invention, preferred embodiments may also include one or more additional second housings.

The invention has advantages including, but not limited to providing one or more of the following features, facilitating secure and convenient mounting of hull devices, improving device adjustability, and providing improved device mounting positions. These and other advantageous features and benefits of the invention can be understood by one of ordinary skill in the arts upon careful consideration of the detailed description of representative embodiments of the invention in connection with the accompanying drawings.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view, from a forward perspective, of an example of a preferred embodiment of the mounting device of the present invention;

FIG. 2 illustrates an exploded view, from an aftward perspective, of an example of a preferred embodiment of the mounting device of the present invention;

FIG. 3 illustrates a partial cross section side view of an example of a preferred embodiment of a universal mount for watercraft according to the invention;

FIG. 4 illustrates an exploded view of an example of a preferred embodiment of the forward plate and the first housing of the present invention;

FIG. 5 illustrates a forward view of an example of a preferred embodiment of the forward plate of the present invention;

FIG. 6 illustrates a side view of an example of a preferred embodiment of the forward plate of the present invention;

FIG. 7 illustrates a view of the aftward side of an example of a preferred embodiment of the first housing of the present invention;

FIG. 8 illustrates a side view of an example of a preferred embodiment of the first housing of the present invention;

FIG. 9 illustrates a view of the forward side an example of a preferred embodiment of the first housing of the present invention;

FIG. 10 illustrates a view of the forward side of an example of a preferred embodiment of a second housing of the present invention;

FIG. 11 illustrates an exploded forward perspective view of an example of a preferred embodiment of the forward plate, the first housing and an alternative preferred embodiment of a second housing of the present invention;

FIG. 12 illustrates a view of the aft side of an example of the alternative preferred embodiment of the second housing of the present invention;

FIG. 13 illustrates a perspective view of an example of an alternative preferred embodiment of the second housing of the present invention;

FIG. 14 illustrates a view of the forward side of an example of an alternative preferred embodiment of the second housing of the present invention; and

FIG. 15 illustrates a forward perspective view of an example of another alternative preferred embodiment of a second housing of the present invention.

References in the detailed description correspond to like references in the various drawings unless otherwise noted. Descriptive and directional terms used in the written description such as front, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features as well as advantages of the invention.

### DESCRIPTION OF PREFERRED EMBODIMENTS

The making and using of various specific exemplary embodiments of the invention are discussed herein. It should be appreciated that the apparatus and systems described and shown exemplify inventive concepts which can be embodied in a wide variety of specific contexts. It should be understood that the invention may be practiced in various applications and embodiments without altering the principles of the invention. For purposes of clarity, detailed descriptions of functions, components, and systems familiar to those skilled in the applicable arts are not included. The invention is described in the context of representative example embodiments. Although variations in the details of the embodiments are possible, each has advantages over the prior art. In general, the preferred embodiments of the present invention provides a mounting device, attachable to the exterior of a boat hull, upon which the user may install one or more transducer(s) and/or other device(s) to the mounting surface of a housing cooperating with appropriate sized fasteners for transducer (or other device) attachment. The cooperation of components of the mounting device enables the user to mount one or more transducer(s) (or other devices) upon the exterior of a boat hull of any degree of deadrise, including aftward-canted transoms characteristic of most transom designs, stepped transoms, and set-back transoms. First and second housings may be used in various combinations, and may be interchangeable with one another and may be used in plurality with appropriately sized fasteners in order to position and mount transducers or other devices relative to selected transoms.

The attachment of transducers to the mounting surface of a housing of the present invention enables the user to effectively move transducer(s) further aftward from the boat transom into the naturally rising slipstream of water, which has been displaced by a planing or fast-moving displacement boat hull. Aftward positioning of transducer(s), upon elevating, or lowering, the face of the transducer into the slipstream of displaced water, provides a corrective advantage toward improving a transducer sounding by reducing or eliminating transducer drag, spray and/or turbulence which may affect a transducer sounding when a transducer is mounted, absent the invention, directly to the transom of a boat hull (adjusted in accordance with mounting instructions provided by its manufacturer) below the running surface of the boat, where a tumultuous “trough” of disturbed water is created by the moving boat hull and transducer drag.

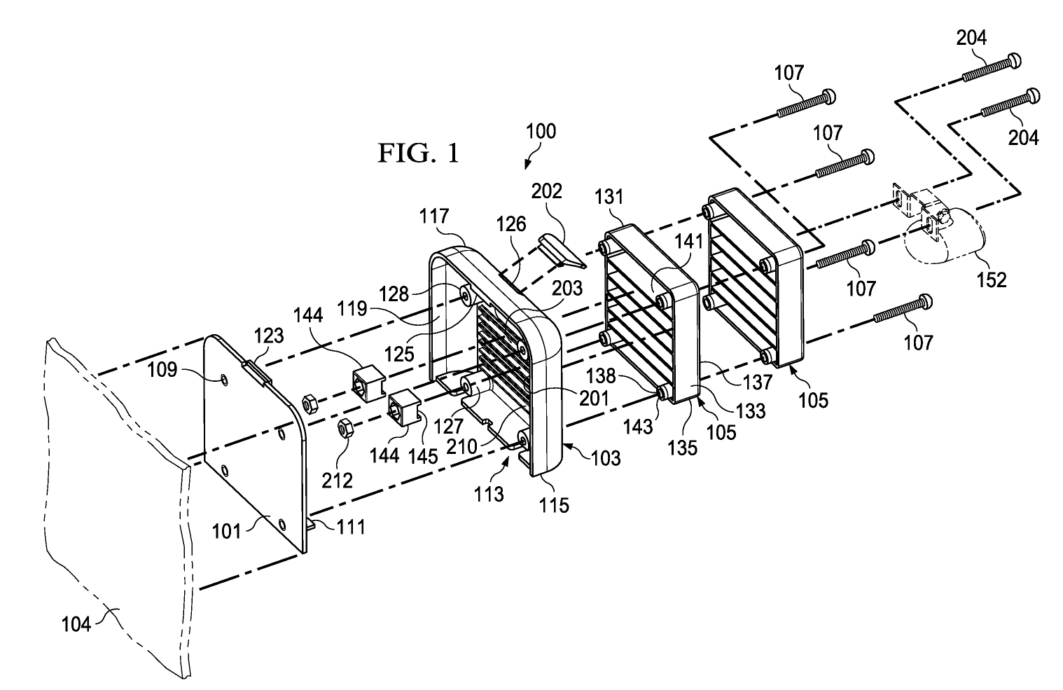

FIG. 1 illustrates an example of a mounting device 100 in accordance with the teachings of the present invention. The mounting device 100 may include a forward plate 101, a first housing 103 and a second housing 105. The forward plate 101 may include mounting arms 111 to cooperate with corresponding slots 113 of the first housing 103, which may be positioned within the first bottom member 115 of the first housing 103 and may include an upward extending arm 123 to cooperate with a downward extending tab 125 which may be connected to a first top member 117 of the first housing 103. The forward 101 may be attached to a boat hull 104 (not part of the invention) by adhesives, mechanical fasteners such as screws, bolts or other methods which can withstand marine environments.

The first housing 103 top member 117 is connected to a pair of opposing first side members 119 and may be connected to a first aft member 201, which is connected to a pair of opposing first side members 119 and may be connected to a first aft member 201, which may be connected to the first side members 119 and the first bottom member 115. The first housing 103 may include an open forward side in order to cooperate with the forward plate 101. The forward surface of the first aft member 201 may include forward extending cylinders 127 having a central aperture 128 in order to cooperate with fasteners such as threaded bolts 107 to connect to threaded nuts 109 attached to or embedded within the forward plate 101.

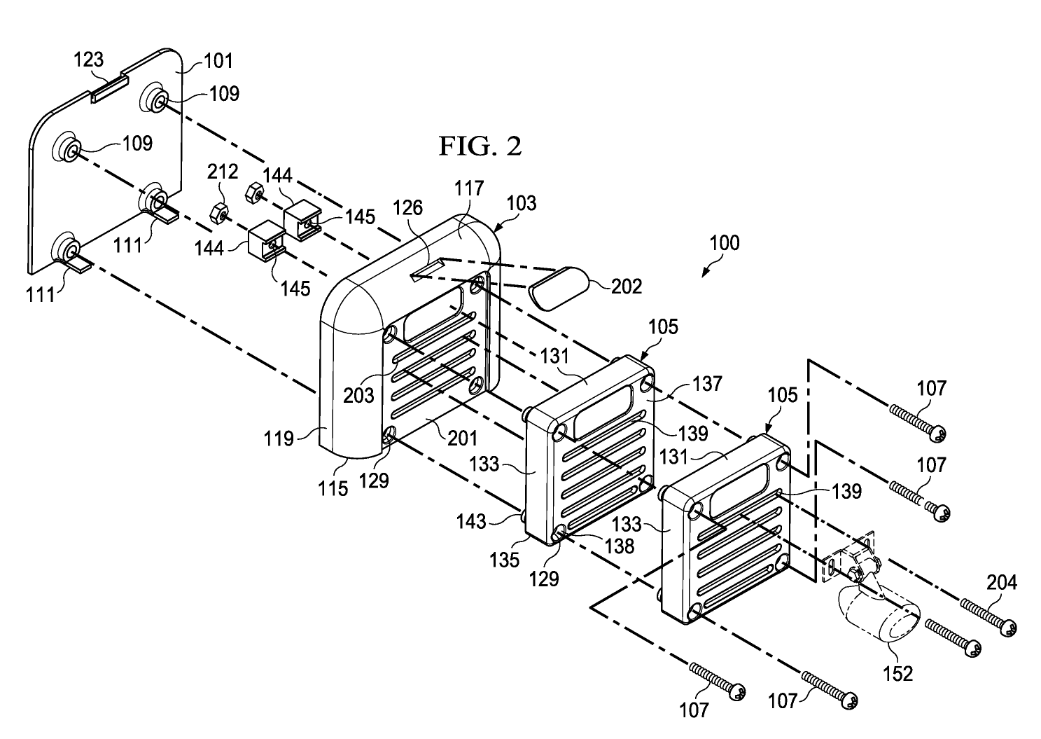

The first top member 117 may include a cover 202 which may provide access to an aperture 126 extending through the first top member 117. The mounting device 100 may include a second housing 105 which may include a second top member 131 connected to opposing second side members 133 in turn connected to a second bottom member 135. The second top member 131, the second side member 133 and the second bottom member 135 may be connected to a second aft member 137. The second aft member 137 may include a slot 139 (FIG. 2) to provide for passage of a fastener device, such as a bolt 204. A fastener block 144 preferably has a channel 145 to cooperate with internal walls 210 of the first and first-housing 103 in order to prevent the fastener block 144 from spinning when the fastener device, e.g., bolt 204, is turned. The second housing 105 may include a second cylinder 143 extending forward and may include a central aperture 138 to cooperate with the threaded bolt 107 and to cooperate with the first cylinder 127 of the first housing 103 and nut 109.

It can be seen that a transducer 152 (not part of the invention) or other apparatus selected by a user may be attached to a second housing 105 by means of fastening devices such as mounting bolts 204. The mounting bolts 204 extend through slots, providing passage through the first housing 103, and preferably one or more (in this example two) second housings 105. Preferably, channels 145 on each of the fastener blocks 144 align with internal horizontal walls 210 of the first housing 103 adjacent to the slots 203. A suitable nut 212 placed in block 144 attached to the mounting bolt 204 completes the fastening. Preferably, the respective horizontal walls 210, 141, and slots 203, 139, fastener blocks 144, and their channels 145 are sized such that the fastener blocks 144 may be positioned on the rear face of first housing 103 according to the decision of a user. Preferably, the interaction of the respective walls and channels prevents the fastener block from spinning freely with the fastening device when the fastening device is turned. It should also be appreciated that some degree of flexibility in the use of second housing(s) 105 is afforded without departure from the principles of the invention. For example, in an application where greater hull clearance is desirable, one, two, or even greater numbers of second housings 105 may be used. To the same end, varying thicknesses of second housings 105 may also be used, and horizontally or vertically extending housings may also be used, as in further examples described and shown herein. In some implementations, the horizontal walls of the housing(s) may be omitted.

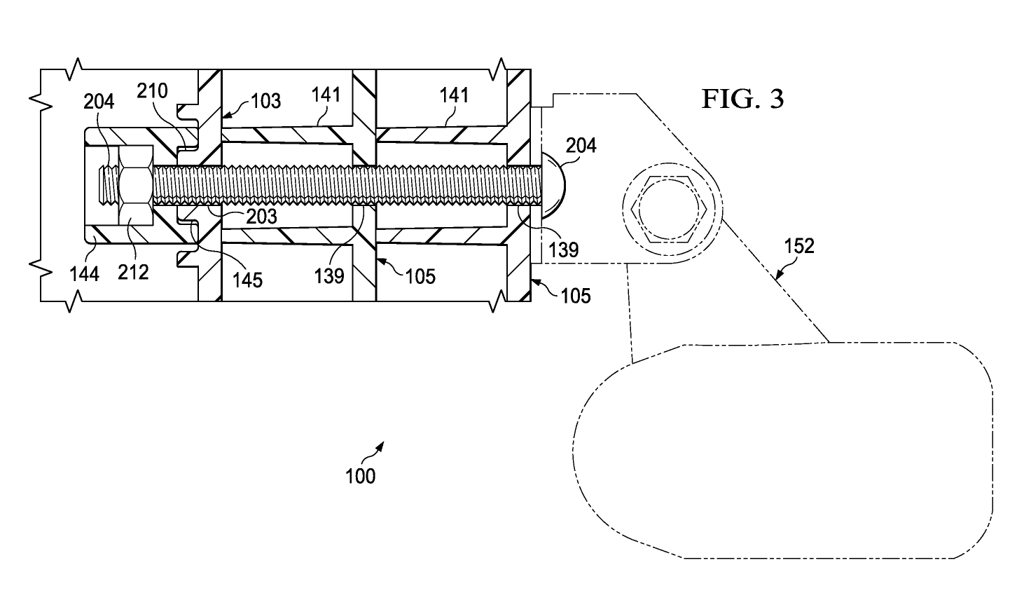

FIG. 2 further illustrates an example of a mounting device 100 in accordance with the teachings of the present invention, also shown in a partial cutaway side view in FIG. 3. The mounting device 100 may include a forward plate 101, a first housing 103 and one or more second housing(s) 105. The forward plate 101 may include mounting arms 111 to cooperate with first slots (113 in FIG. 1) of the first housing 103 which may be positioned within the first bottom member 115 of the first housing 103, and may include an upward extending arm 123 to cooperate with a downward extending tab (125 in FIG. 1) of the first top member 117.

The first housing 103 may include a first top member 117, which may be downward sloping, connected to a pair of opposing first side members 119 and connected to a first aft member 201, connected to the first side members 119 and first bottom member 115. The first housing 103 may include an open forward side in order to cooperate with the forward plate 101. The forward surface of the first aft member 201 may include forward extending cylinders 127 (shown in FIG. 1) each having a central aperture 128 (shown in FIG. 1) in order to cooperate with fasteners devices such as threaded bolts 107 configured to connect to threaded nuts 109 embedded within the forward plate 101, or otherwise affixed thereto.

The first top member 117 may include a cover 202 which may provide access to an aperture 126 extending through the first top member 117.

The mounting device 100 may include one or more second housing(s) 105 having a second top member 131 connected to opposing second side members 133 and also connected to a second bottom member 135. The second top member 131, the second side member 133, and the second bottom member 135 are connected to a second aft member 137. The second housing 105 may include second cylinders 143 extending forward, each including a central aperture 138 to cooperate with the threaded bolts 107 and to cooperate with the first forward extending cylinders 127 (FIG. 1) and aftward-facing counterbores 129 of the first housing 103.

The transducer 152 (not part of the invention) preferably includes mounting bolts 204 extending through the first slot 203 and the second slot 139 (FIG. 1) threadably connected to the fastening block 144, e.g., secured with a nut 212.

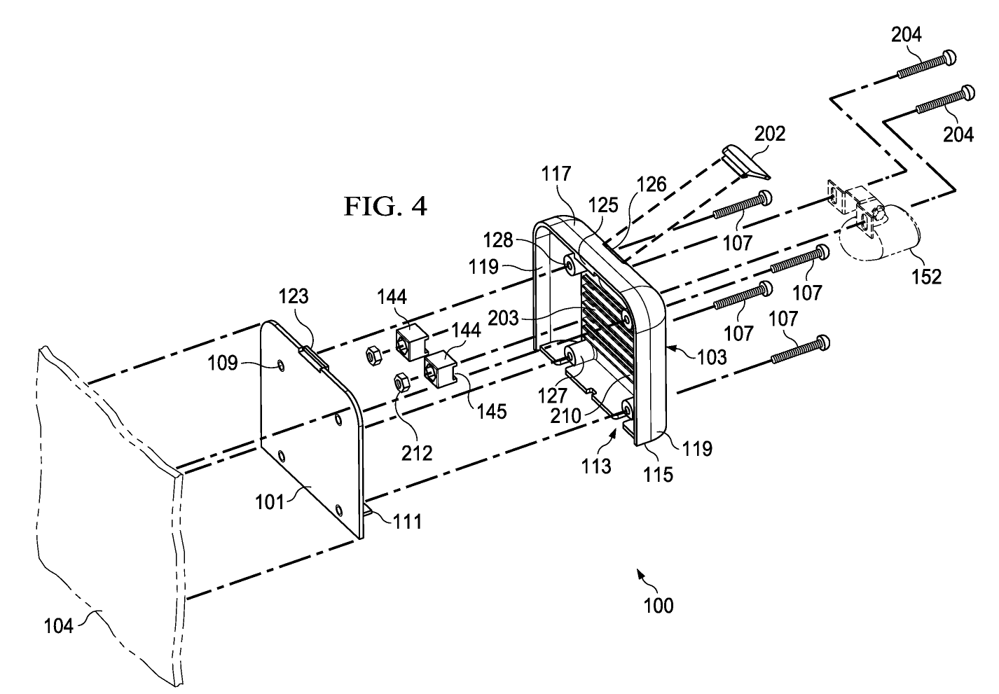

Now referring to FIG. 4, an alternative view of an exemplary embodiment of a mounting device 100 in accordance with the teachings of the present invention is shown. The mounting device 100 includes a forward plate 101 and a first housing 103. The forward plate 101 may include mounting arms 111 to cooperate with corresponding slots 113 of the first housing 103 positioned within the first bottom member 115 of the first housing 103, and may include an upward extending arm 123 to cooperate with a downward extending tab 125 connected to the first top member 117.

The first housing 103 may include a first top member 117, which may be downward sloping and may be connected to a pair of opposing first side members 119. The first housing 103 may include an open forward side in order to cooperate with the forward plate 101. Forward extending cylinders 127 having a central aperture 128 are configured to cooperate with fastener devices such as threaded bolts 107 to connect to threaded nuts 109 preferably attached to or embedded within the forward plate 101.

The first top member 117 may include a cover 202 which may provide access to an aperture 126 extending through the first top member 117.

A transducer 152 or other device (not part of the invention) may be mounted using mounting bolts 204 extending through the first slot 203 and threadably connected to a nut 212 through an intervening fastening block 144. Preferably, walls 210 on the forward side of the first housing 103 run the length of the slots 203 and cooperate with the channel 145 in the fastening block 144 to prevent spinning of the nut 212 when the fastener 204 is turned. It should be appreciated by those skilled in the arts that the walls may be omitted in some alternative embodiments without departure from the principles of the invention.

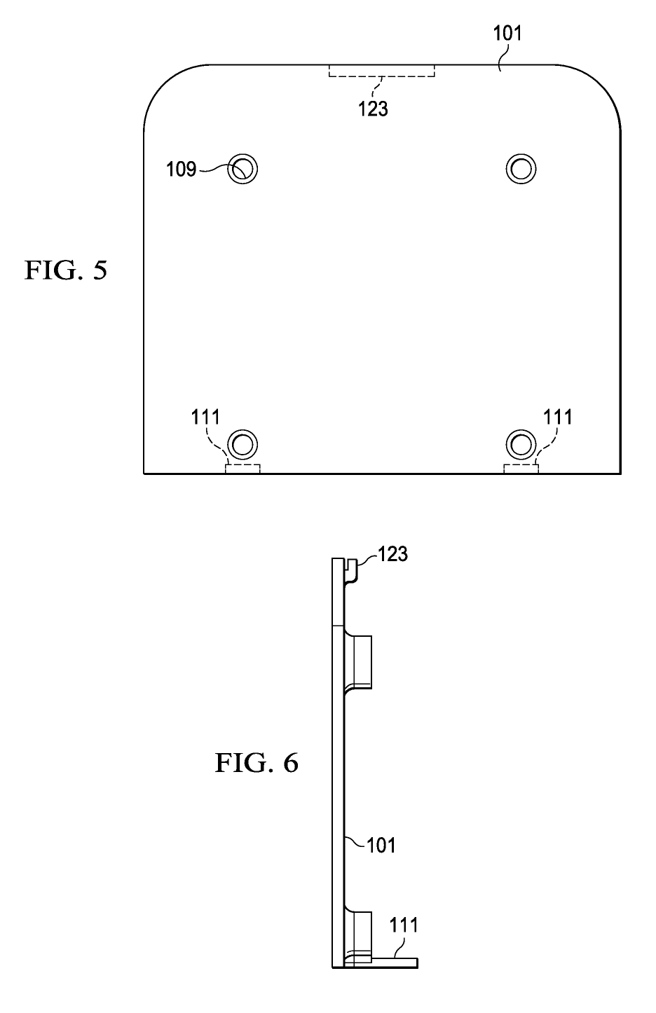

FIG. 5 and FIG. 6 illustrate close-up forward and side views respectively of an example of a forward plate 101 according to preferred embodiments of the invention. An upward extending arm 123 is designed to cooperate with a downward extending tab 125 of first housing 103, (see, e.g., FIG. 3) wherein the arm 123 and tab 125 (FIG. 4) cooperate to form a mechanical connection between the forward plate 101 and the first housing 103. Preferably, mounting arms 111 also form a mechanical connection when inserted in slots 113 to secure the first housing 103 to the forward plate 101. Threaded nuts 109 are preferably attached to or embedded within the forward plate 101 in positions suitable to accept threaded bolts (e.g., 107 as shown in FIG. 1). The nuts 109 may be incorporated into the forward plate 101 using injection molding techniques, may be machined into the forward plate material itself, or may be affixed to the forward plate 101 using other suitable means.

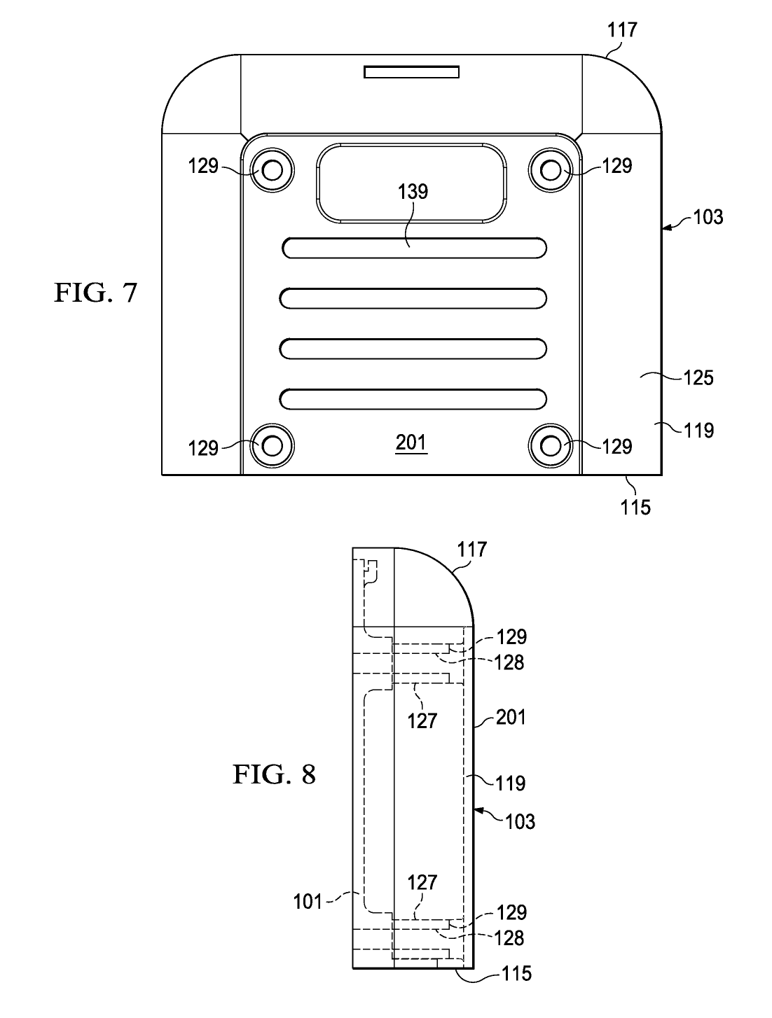

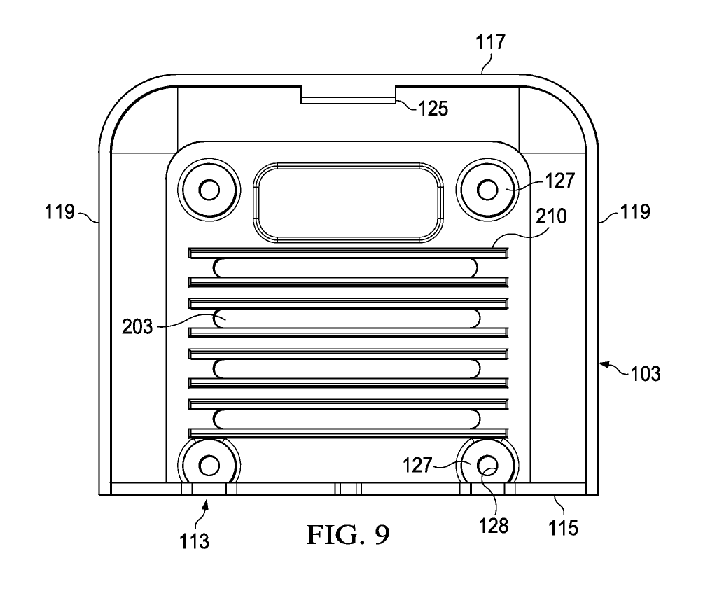

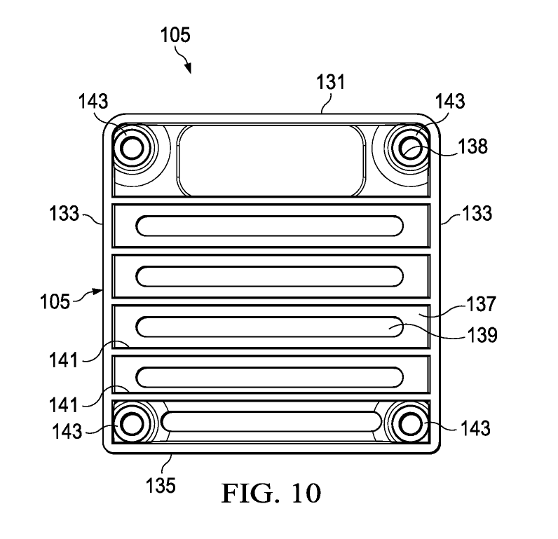

FIGS. 7 and 8 illustrate aft and side views respectively of an example of the first housing 103 and illustrates the relationships among first top member 117, the first bottom member 115, the first side member 119 and the first front member 201. Also shown, is the cylinder 127 including the central aperture 128 for accepting a fastener 107. A counterbore recess 129 is provided to accept the head of a fastener, or to accept a forward extending cylinder (143 in FIG. 10) from an adjacent second housing. FIG. 9 depicts a forward view of an exemplary first housing 103. The first top member 117, the first bottom member 115, the first side member 119 and the downward extending tab 125 are shown, as are the preferred positions of cylinders 127, apertures 128, walls 210 and slots 139.

FIG. 10 illustrates a forward view of an example of a second housing 105 and illustrates the second bottom member 135 the second side member 133, and the second top member 131. FIG. 10 additionally illustrates the second slots 139 and the second cylinders 143 and apertures 138. The forward extending cylinders 143 preferably may be aligned to rest in corresponding counterbore recesses (e.g., 129 in FIG. 7) on an adjacent first or second housing to interlock in a stacked configuration.

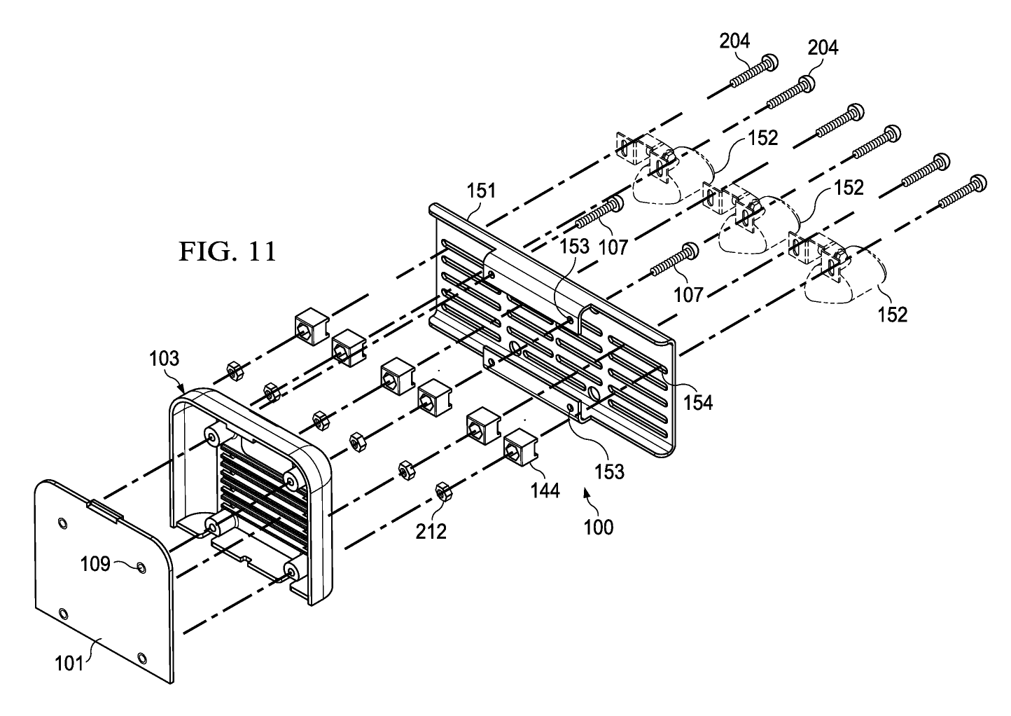

FIG. 11 illustrates the forward plate 101, the first housing 103 and an alternative embodiment of a second housing 151. In this example of an alternative embodiment, the second housing 151 shown is made of rigid material suitable for immersion, such as corrosion-resistant metal or plastic. Multiple transducers 152 (not part of the invention) are shown mounted on the second housing 151. Transducers 152 are fastened on the aft side of the second housing 151, the mounting bolts 204 being inserted through slots 154 in the second housing 151 and secured. The second housing 151, as shown, may be configured to accommodate multiple transducers or other similar apparatus mounted by fasteners 204 to its aft-facing surface. The second housing 151 is preferably made of rigid material suitable for immersion, such as corrosion-resistant metal or plastic. It should be noted that, in some applications, it may be preferred to omit the first housing 103 in an alternative implementation of the invention. It should be understood that in some applications it may be preferable to use a second housing embodiment as shown at 151 mounted on a second housing 105 (FIG. 1), or stacked second housings 105, or may require a such second housing(s) (105), individually or stacked, to be mounted on an alternative second housing 151.

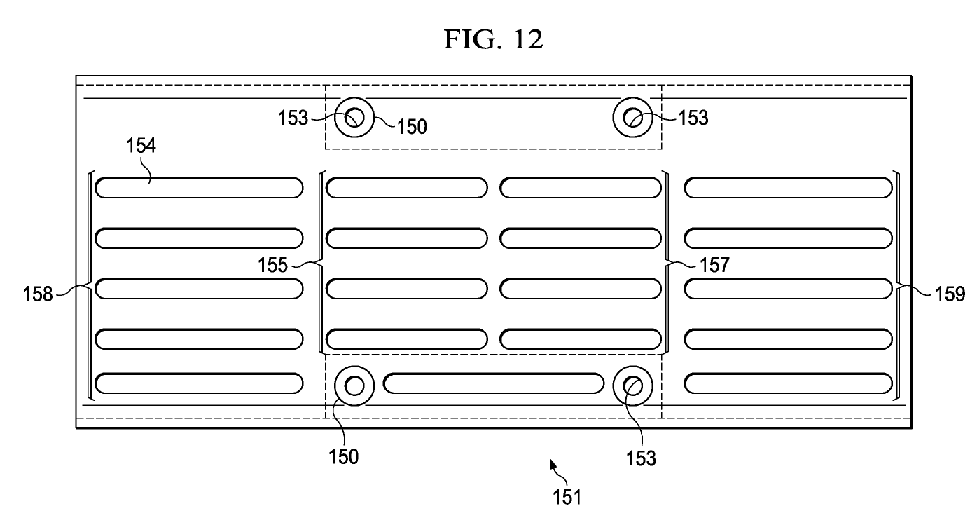

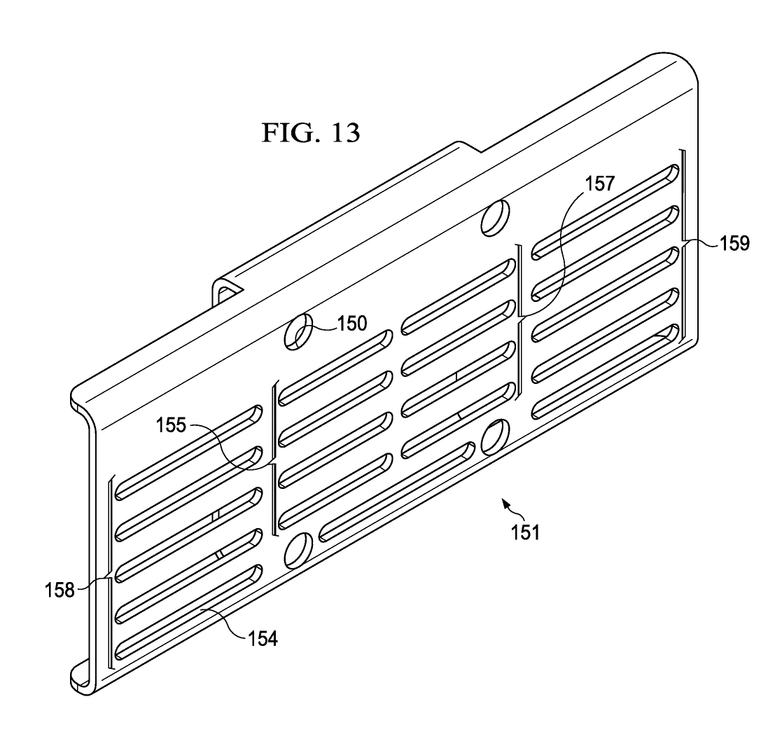

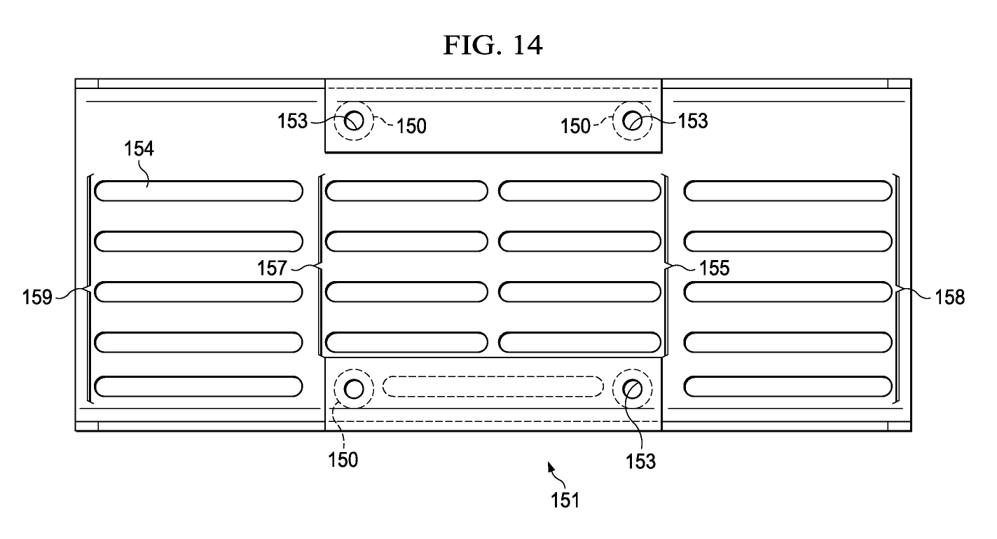

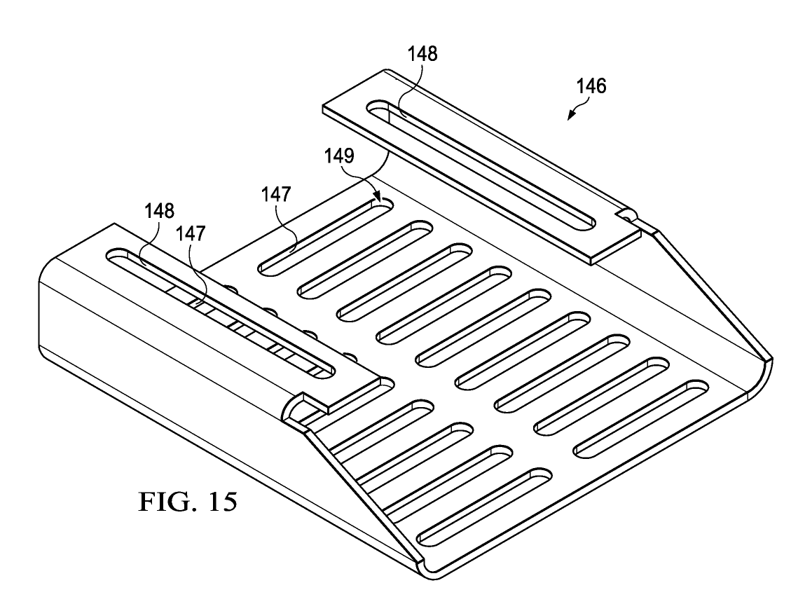

FIGS. 12 through 14 depict various views of an example of a preferred embodiment of the alternative second housing 151. FIG. 12 illustrates an aft view of the alternative embodiment of the second housing 151. FIG. 13 depicts an aft perspective view, and FIG. 14 is a forward view. Preferably, the second housing 151 has a substantially rectangular surface suitable for mounting one or multiple transducers or similar apparatus. It is contemplated that one, two, three, or four transducers or other devices may typically be used on a second housing 151. The second housing 151 may include apertures 150, 153 to cooperate with the threaded bolts 107 (e.g., FIG. 11) to connect to the forward plate 101. The second housing 151 may include a first row 153 of slots 154, a second row 155 of slots 154, a third row 157 of slots 154 and a fourth row 159 of slots 154. Additional or fewer rows of slots are within the scope of the invention. The slots row can be used to mount a transducer or multiple transducers on the second housing 151. This reduces the need for multiple single transducer mounts.

FIG. 15 portrays an example of a preferred alternative embodiment of a second housing 146 in a forward perspective view. In this example, the second housing 146 is longer than it is wide. First slots 147 are provided for accommodating bolts for mounting one or more transducers or other devices in the manner described herein, e.g., with reference to FIG. 11, above. Second slots 148, preferably perpendicular to first slots 147, allow fasteners, such as bolts 107 (e.g., FIG. 11) to pass through for securing the second housing 146 to a first housing 103 (FIG. 9) or second housing 105 (FIG. 10). It should be noted that the bolts (107, FIG. 1) may pass through the second housing 146 at any position selected by a user where the slots 147, 148 correspond, as indicated at arrow 149. The vertical slots 148 accept bolts which pass through the horizontal slots 203, 139, of a first housing 103 or a second housing 105, for fastening through to mounting blocks 144 with suitable nuts, preferably for assembling loosely initially, in order to slide vertically to proper position before tightening. One or more transducers 152 fasten to the back side of the alternative embodiment of the second housing 146 in a manner similar to the manner described for the second housing 151 shown in and described with respect to FIG. 11. The second housing 146 may be inverted to gain more height or more depth as required, and the second housing 146 may be mounted on a second housing 151 (e.g., FIG. 14), permitting the user to select which of the various slots to use to accept fastenings.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

The apparatus and systems of the invention provide one or more advantages including, but not limited to, providing secure mounting means for attaching a transducer or other apparatus to the exterior of a boat hull, providing mounts configured for avoiding or mitigating turbulence, providing mounts suitable for mounting multiple devices, and avoiding hull damage. While the invention has been described with reference to certain illustrative embodiments, those described herein are not intended to be construed in a limiting sense. For example, variations or combinations of components and arrangements in the embodiments shown and described may be used in particular cases without departure from the invention. Although the presently preferred embodiments are described herein in terms of particular examples, modifications and combinations of the illustrative embodiments, as well as other advantages and embodiments of the invention, will be apparent to persons skilled in the arts upon reference to the drawings, description, and claims.

I claim:

1. A mounting device for mounting a transducer to the transom of a boat hull, comprising:
a forward plate to mount to the transom of the boat hull;
a first housing to detachably connect to the-forward plate;
a second housing to detachably connect to the first housing;
wherein the first housing includes a first slot to cooperate with a fastening device to connect the transducer to the first housing; and
wherein the second housing includes a second slot to cooperate with the fastening device and to cooperate with the first slot to connect the transducer to the second housing.

2. A mounting device for mounting a transducer to the transom of a boat hull as in claim 1, wherein the first housing includes an open forward side.

3. A mounting device for mounting a transducer to the transom of a boat hull as in claim 1, wherein the second housing includes an open forward side.

4. A mounting device for mounting a transducer to the transom of a boat hull as in claim 1, wherein the first housing includes a first horizontal wall to cooperate with the fastener device.

5. A mounting device for mounting a transducer to the transom of a boat hull as in claim 1, wherein the second housing includes a second horizontal wall.

6. A mounting device for mounting a transducer to the transom of a boat hull, comprising:
a forward plate to mount to the transom of the boat hull;
a first housing to detachably connect to the forward plate, the first housing having aftward facing counterbore recesses;
a second housing to detachably connect to the first housing, the second housing having forward facing cylinders;
wherein the first housing includes a first slot to cooperate with a fastening device to connect the transducer to the first housing;
wherein the second housing includes a second slot to cooperate with the fastening device and to cooperate with the first slot to connect the transducer to the second housing; and
wherein the forward facing cylinders and aftward facing counterbore recesses are arranged in a configuration adapted for stacking.

7. A mounting device for mounting a transducer to the transom of a boat hull as in claim 6, wherein the second housing extends beyond the first housing.

8. A mounting device for mounting a transducer to the transom of a boat hull as in claim 7, wherein the second housing horizontally extends beyond the first housing.

9. A mounting device for mounting a transducer to the transom of a boat hull as in claim 7, wherein the second housing is adapted to receive a plurality of transducers.

10. (canceled)

11. (canceled)

12. A mounting device for mounting a transducer to the transom of a boat hull as in claim 1, wherein the first housing further comprises aftward facing counterbore recesses; and
wherein the second housing further comprises forward facing cylinders;
whereby the forward facing cylinders and aftward facing counterbore recesses are arranged in a configuration adapted for stacking.

13. A mounting device for mounting a transducer to the transom of a boat hull as in claim 7 further comprising a second housing adapted for sliding vertically in relation to the forward plate, whereby the second housing may be adjusted vertically with respect to the watercraft.

14. A universal mount for mounting apparatus to watercraft comprising:
a forward plate for affixing to the watercraft;
a first housing removably affixable to the forward plate;
a fastener block for removably mounting apparatus adjacent to the first housing;
wherein the first housing is interposed between the fastener block and the apparatus; and
wherein the first housing comprises a plurality of slots for receiving bolts, each bolt having an end at the apparatus and an opposite end terminating at the fastener block.

15. The universal mount for mounting apparatus to watercraft according to claim 14 further comprising one or more second housing interposed between the first housing and the apparatus.

16. The universal mount for watercraft according to claim 14 further comprising a second housing configured for accepting more than one apparatus for mounting.

17. The universal mount for watercraft according to claim 14 further comprising a second housing machined from metal.

18. The universal mount for watercraft according to claim 14 further comprising a second housing molded from plastic.

19. The universal mount for watercraft according to claim 14 further comprising a second housing broader in horizontal dimensions than the forward plate.

20. The universal mount for watercraft according to claim 14 further comprising a second housing taller in vertical dimensions than the forward plate.

21. The universal mount for watercraft according to claim 14 wherein the first housing further comprises aftward facing counterbore recesses; and
wherein the second housing further comprises forward facing cylinders;
whereby the forward facing cylinders and aftward facing counterbore recesses are arranged in a configuration adapted for stacking.

22. The universal mount for watercraft according to claim 14 further comprising a second housing adapted for sliding vertically in relation to the forward plate, whereby the second housing may be adjusted vertically with respect to the watercraft.
